(19) United States
(12) Patent Application Publication
(10) Pub. No.: US 2026/0169754 A1
(43) Pub. Date: Jun. 18, 2026

(54) SELECTIVE BOOT CYCLE MODES

(71) Applicant: Micron Technology, Inc., Boise, ID (US)

(72) Inventor: Liu Zhao, Shanghai (CN)

(21) Appl. No.: 18/720,804

(22) PCT Filed: Jun. 21, 2023
(86) PCT No.: PCT/CN2023/101665

§ 371 Date: Jun. 17, 2024

(51) Int. Cl. G06F 9/4401

(52) U.S. Cl. CPC G06F 9/4401

(57) ABSTRACT

Methods, systems, and devices for selective boot cycle modes are described. A boot cycle may be performed to power-on a memory system, and may include full power cycles associated with data generation and reliability, or limited power cycles associated with fewer operations. The memory system may determine whether to perform a full power cycle or a limited power cycle during the boot cycle based on detected conditions. For example, if the memory system was powered down with a start stop unit prior to performing the boot cycle, the memory system may determine to perform a limited power cycle during the boot cycle. However, if the memory system receives a write command, the memory system may determine to perform the full power cycles for a remainder of the boot cycle. The memory system may store a flag indicating whether to perform a full power cycle or a limited power cycle.

### CROSS REFERENCE

The present Application for Patent is a 371 national phase filing of International Patent Application No. PCT/CN2023/101665 by Zhao, entitled “SELECTIVE BOOT CYCLE MODES,” filed Jun. 21, 2024, assigned to the assignee hereof, and expressly incorporated by reference in its entirety herein.

### TECHNICAL FIELD

The following relates to one or more systems for memory, including selective boot cycle modes.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states in response to being disconnected from an external power source.

### BRIEF DESCRIPTION OF THE DRAWINGS

FIG. 1 shows an example of a system that supports selective boot cycle modes in accordance with examples as disclosed herein.

FIG. 2 shows an example of a process that supports selective boot cycle modes in accordance with examples as disclosed herein.

FIG. 3 shows a block diagram of a memory system that supports selective boot cycle modes in accordance with examples as disclosed herein.

FIG. 4 shows a flowchart illustrating a method or methods that support selective boot cycle modes in accordance with examples as disclosed herein.

### DETAILED DESCRIPTION

A memory system may perform (e.g., undergo) a boot cycle to transition from a powered-off state to a powered-on state. The boot cycle may include different phases. For example, the boot cycle may include a flash storage phase, a kernel loading phase, and an operating system phase. Before each phase of the boot cycle, a power cycle of the memory system may occur. In some cases, the power cycle may occur because the memory system is being started (e.g., before the first phase). After each phase of the boot cycle, a hardware reset may occur. A power cycle may also occur after a hardware reset occurs.

Example of power cycles may include full power cycles (e.g., dirty power cycles) and partial power cycles (e.g., clean power cycles). A full power cycle may include operations related to data generation (e.g., logical-to-physical tables) and ensuring data reliability (e.g., among other processes) of the memory system. In some cases, the full power cycles may facilitate the powering ON and restoration of the memory system to normal operation. A limited power cycle (e.g., clean power cycles) may be performed in response to conditions detected within the memory system. Each limited power cycle may involve operations that enable the memory system to power ON with a reduced emphasis on data generation and data reliability. For example, each limited power cycle may include relatively fewer operations directed to data generation and reliability than a respective full power cycle (e.g., a dirty power cycle).

The memory system may use different techniques to determine whether to use a full power cycle or a limited power cycle during a boot operation. For example, the memory system may store a flag (e.g., a PON flag) in a non-volatile memory device of the memory system, indicating whether to perform the limited power cycles or the full power cycles during the boot cycle. The flag may be set based on a variety of different criteria and/or thresholds.

In some cases, the flag may be set to cause the memory system to perform limited power cycles in response to the memory system being powered OFF by a start-stop unit (SSU). In other cases, the memory system may experience a power loss (e.g., an asynchronous power loss). In such cases, the memory system may have performed write operations (e.g., data storage in the volatile memory device) or other operations that could lead to data loss. In these cases, the flag may be set to cause the memory system to perform the full power cycles (e.g., dirty power cycles), which involve data regeneration and other processes associated with high bandwidth consumption and latency. In other cases, the flag may be set to cause the memory system to perform a full power cycle in response to a hardware reset being performed (e.g., as part of the boot cycle). In some examples, the memory system may experience an unexpected power loss (e.g., an asynchronous power loss), where the memory system is abruptly powered OFF without completing the operations to ensure data reliability. Similarly, a hardware reset may also compromise data reliability. In some cases, the memory system may perform the full power cycles (e.g., dirty power cycles) to regenerate lost data (e.g., erased data in the volatile memory device) after experiencing a power loss or after experiencing a hardware reset. Therefore, performing the full power cycles after powering OFF the memory system via the SSU, or after powering OFF the memory system without performing write operations or other operations, or after performing a hardware reset, may result in unnecessary usage of computing resources, power resources, and time during powering ON the memory system.

Techniques are described to use limited power cycles as part of boot cycles of memory systems in more scenarios. Some memory systems may perform a limited power cycle if the memory system was powered OFF by the SSU. However, once a hardware reset is performed as part of the boot cycle, the memory system may perform full power cycles thereafter (e.g., by setting a value of the flag to indicate to perform the limited power cycles). In some cases, the memory system refrain from setting a value of the flag to indicate to perform full power cycles after a hardware reset during a boot cycle. Instead, the memory system may determine whether a write command is executed as a criterion to alter a value of the flag. For example, if a write command is detected, the memory system may set the value of the flag to indicate to perform the full power cycles (e.g., to “false” or “0”). Said another way, after experiencing a power loss or a hardware reset, the memory system may default to setting the flag to indicate that the memory system is to perform the full power cycles during the boot cycle. With these techniques, however, the memory system may leave the flag as indicating to perform limited power cycles after a hardware reset if no write operations have been performed. Later, after detecting a write command, the memory system may change the value of the flag to indicate to perform the full power cycles. Consequently, rather than defaulting to performing the full power cycles in some situations, the memory system may implement the limited power cycles if applicable, resulting in lower bandwidth consumption and latency compared to previous implementations. That is, the techniques described herein may reduce bandwidth consumption and latency by selectively employing limited power cycles during a boot operation of the memory system, based on conditions and the value of the flag stored in the memory system.

In some cases, the limited power cycles may be initiated during a boot cycle of the memory system in response to the memory system detecting that it was powered OFF by the SSU or in response to detecting a lack of write or erase commands in a command buffer of the memory system (e.g., the volatile memory device of the memory system). However, after detecting a write command, the memory system may transition from the limited power cycles to the full power cycles (e.g., which include operations directed to data generation and reliability).

Features of the disclosure are illustrated and described in the context of systems, devices, and circuits. Features of the disclosure are further illustrated and described in the context of a process, a block diagram, and a flowchart.

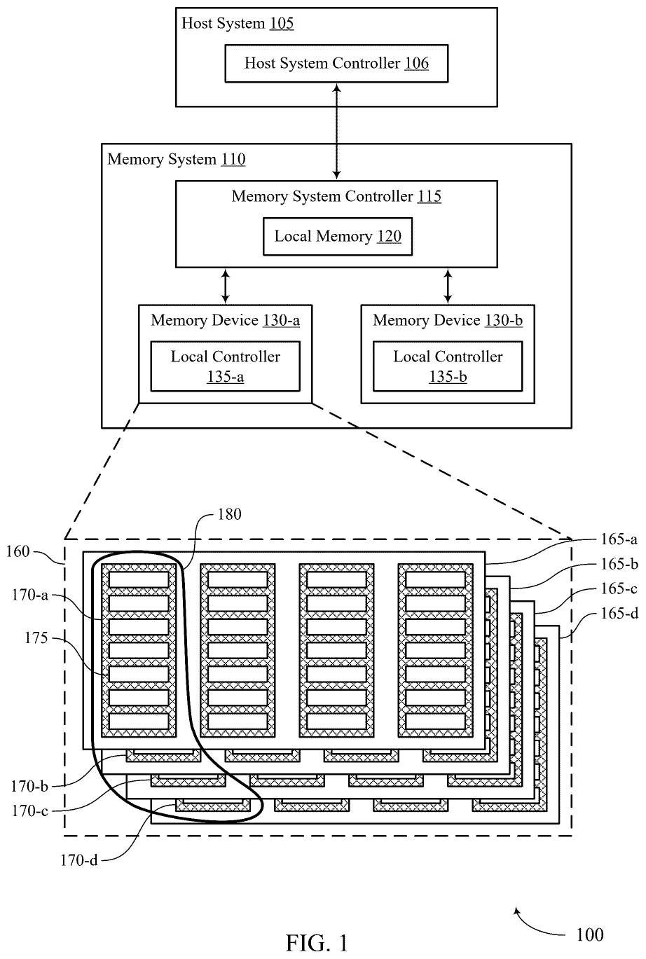

FIG. 1 shows an example of a system 100 that supports selective boot cycle modes in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells, synchronous DRAM (SDRAM) memory cells, and static RAM (SRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support selective boot cycle modes. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, the memory system 110 may include a command queue in one of the memory devices 130. For example, the memory system 110 may implement a command queue in a volatile memory array of a memory device 130. The command queue may be configured to store commands for performing operations on a non-volatile memory array of a memory device 130. For example, the command queue may be configured to store write commands, read commands, erase commands, or reset commands. In some cases, the commands may be temporarily stored in the command queue in an order of recency, such that commands received most recently may be stored to an end of the command queue and performed after each command received prior is performed.

In some cases, the memory system 110 may be configured to perform a boot cycle. The boot cycle may be associated with transitioning (e.g., switching) the memory system 110 from a relatively low power state (e.g., an “OFF” state, a deep sleep state, a rest state) to a relatively high power state (e.g., an “ON” state). The boot cycle may include a quantity of power cycles, where the power cycles may be implemented as full power cycles or limited power cycles. In some examples, the power cycle may be triggered by a command from the host system 105 or by a hardware reset of the memory system.

In some cases, the memory system 110 may be configured to perform limited power cycles (e.g., clean power cycles) during a boot cycle in response to conditions detected within the memory system. Each limited power cycle may include relatively fewer operations directed to data generation and data reliability than a respective full power cycle during a boot cycle to power ON the memory system 110. The limited power cycles may be initiated in response to the memory system 110 detecting that it was powered OFF by an SSU or in response to detecting a lack of write or erase commands in a command buffer of the memory system 110. However, after detecting one or more write commands, the memory system 110 may transition (e.g., switch) from the limited power cycles to the full power cycles that include operations directed to data generation and reliability.

For example, the memory system 110 may store a flag (e.g., a PON flag) indicating whether to perform the limited power cycles or the full power cycles during the boot cycle. If the memory system 110 was powered OFF by the SSU, the memory system 110 may set a value of the flag to indicate to perform the limited power cycles (e.g., to “true” or “1”). However, if one or more write commands are detected, the memory system 110 may set the value of the flag to indicate to perform the full power cycles (e.g., to “false” or “0”).

Initially, the memory system 110 may default to performing the limited power cycles during the boot cycle; however, after detecting one or more write commands, the memory system 110 may update the value of the flag to perform the full power cycles. Thus, rather than defaulting to performing the full power cycles, the memory system 110 may implement the limited power cycles if applicable. The techniques described herein may support decreased bandwidth consumption and delay (e.g., compared to previous implementations) by selectively supporting the limited power cycles during the boot operation of the memory system 110, based on the conditions and the value of the flag stored in the memory system 110.

In addition to applicability in memory systems as described herein, techniques for selective boot cycle modes may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by reducing bandwidth consumption and decreasing latency during powering on electronic devices based on selectively implementing limited power cycles during a boot cycle.

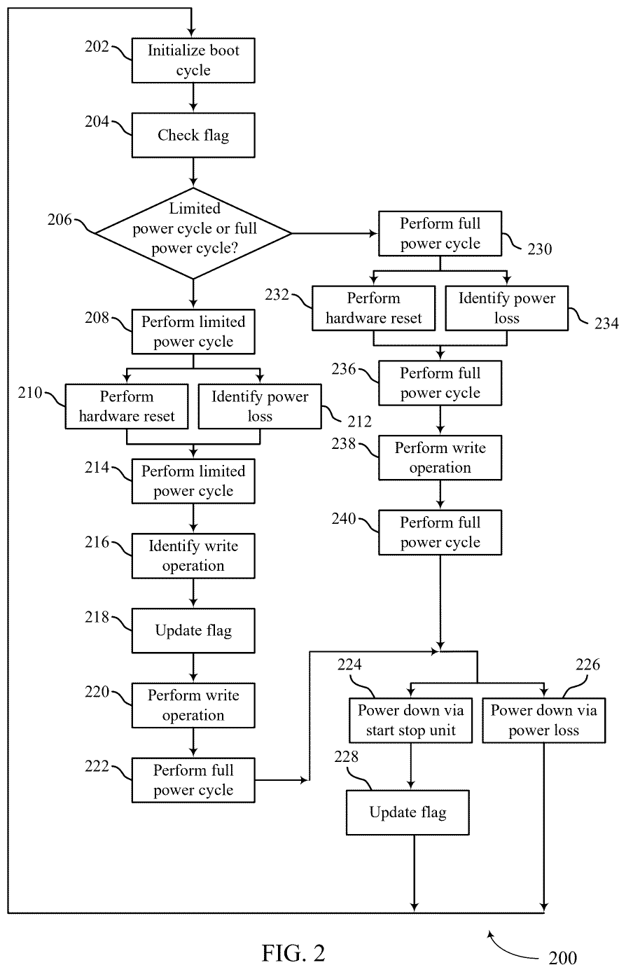

FIG. 2 shows an example of a process 200 that supports selective boot cycle modes in accordance with examples as disclosed herein. The process 200 may illustrate aspects or operations of a system, which may be an example of a system 100, as described with reference to FIG. 1. In the following description of the process 200, the methods, techniques, processes, and operations may be performed in different orders or at different times. Further, certain operations may be left out of the process 200, or other operations may be added to the process 200. Aspects of the process 200 may be implemented by a controller, among other components. Additionally, or alternatively, aspects of the process 200 may be implemented as instructions stored in memory (e.g., firmware). For example, the instructions, if executed by a controller, may cause the controller to perform the operations of the process 200. The process 200 may depict operations associated with performing a boot cycle based on selectively implementing limited power cycles. For example, the process 200 shows operation paths associated with performing the boot cycle using full power cycles and limited power cycles.

The process 200 may be implemented at a host system or a memory system, which may be examples of a host system 105 or a memory system 110, as described with reference to FIG. 1. In some examples, the process 200 or specific operations of the process 200 may be implemented by a controller of the host system or the memory system, such as a host system controller 106, a memory system controller 115, or a local controller 135-a, as described with reference to FIG. 1. For example, the process 200 may depict operations on a memory system, facilitated by a controller of the memory system.

The process 200 depicts operations for powering ON the memory system with a boot cycle. The boot cycle may include operations associated with transitioning the memory system from a relatively low power state (e.g., “OFF” state, deep sleep state, rest state) to a relatively high power state (e.g., “ON” state). The memory system may include a non-volatile memory device (e.g., a NAND memory device) and a volatile memory device (e.g., an SRAM memory device), which may be examples of memory devices 130 (e.g., memory device 130-a, memory device 130-b), as described with reference to FIG. 1. In some cases, the non-volatile memory device and the volatile memory device may be coupled with the controller of the memory system, such that the controller may be configured to facilitate operations on the non-volatile memory device and the volatile memory device.

The volatile memory device may include a command queue configured to temporarily store commands (e.g., write commands) for accessing (e.g., writing, erasing) the non-volatile memory device. For example, the command queue may be configured to store write commands in an order at least partially based on a recency of receiving the commands, and for a duration associated with completing write commands higher in the order. A register of the memory system (e.g., non-volatile memory) may be configured to store a flag (e.g., a PON flag) indicating whether to perform full power cycles (e.g., dirty power cycles) or limited power cycles (e.g., clean power cycles) during the boot cycle. For example, a value (e.g., a bit value) of the flag may be set (e.g., to a “0” value, to a “false” value) to indicate the memory system to perform the full power cycles or the value of the flag may be set (e.g., to a “1” value, to a “true” value) to indicate the memory system to perform the limited power cycles. The memory system may also include a read-only memory (e.g., a programmable read-only memory) configured to store information associated with performing the boot cycle. For example, the read-only memory may include one-time programmable memory elements (e.g., fuses, antifuses) configured to store instructions for performing the boot cycle, including instructions for performing the full power cycles or the limited power cycles. In some examples, the read-only memory may be a portion of the non-volatile memory device. In some cases, the memory system may include a power control device configured to perform operations associated with powering down or powering ON the memory system.

The boot cycle may include a quantity of power cycles, which may be implemented as full power cycles or limited power cycles. The full power cycles and limited power cycles may each involve operations directed to transitioning the memory system from the relatively low power state to the relatively high power state. The full power cycles may involve operations directed to data generation, data regeneration, and data reliability. In some cases, the full power cycles may include regenerating data lost (e.g., erased) from the volatile memory device during a power loss (e.g., an unexpected power loss, an asynchronous power loss). For example, the full power cycles may include regenerating an L2P mapping table stored in the volatile memory device, where the L2P mapping table includes mapping information for the non-volatile memory device. In another example, the full power cycles may include regenerating data (e.g., user data, operation data, metadata) stored in a cache of the volatile memory device, or commands stored in the command buffer. In some cases, the limited power cycles may also involve operations directed to data generation, data regeneration, and data reliability. However, the limited power cycles may include a relatively fewer quantity of operations (e.g., directed to data generation, data regeneration, and data reliability) than the full power cycles. Accordingly, implementing the limited power cycles during the boot cycle may reduce bandwidth consumption and latency during the boot cycle compared to the full power cycles.

At 202, the boot cycle may be initialized at the memory system. In some cases, the boot cycle may be triggered or facilitated by the host system or by a controller of the memory system. In some examples, the boot cycle may be initiated after the memory system was powered down by a SSU command. For example, the host system may transmit a SSU command to the controller of the memory system, and the controller may power down the memory system. In other examples, the boot cycle may be initiated after the memory system was powered down by a power loss (e.g., an unexpected power loss, an asynchronous power loss).

At 204, the flag stored in the register of the non-volatile memory device may be checked in response to initializing the boot cycle. For example, the controller may check the flag to determine whether the value of the flag indicates to perform the limited power cycles (e.g., a “1” or “true” value) or the full power cycles (e.g., a “0” or “false” value) as part of the boot cycle. In some cases, the value of the flag may indicate to perform the limited power cycles in response to the memory system being powered down by a SSU command prior to the boot cycle. In other cases, the value of the flag may indicate to perform a last type of power cycle (e.g., a full power cycle, a limited power cycle) in response to the memory system being powered down by a power loss prior to the boot cycle. For example, if the memory system performed a limited power cycle (e.g., and did not perform a write operation) as the last power cycle before the power loss, the value of the flag may indicate to perform limited power cycles. However, if the memory system performed a full power cycle (e.g., or performed a write operation since performing a limited power cycle) as the last power cycle before the power loss, the value of the flag may indicate to perform full power cycles.

At 206, the controller may determine whether to perform limited power cycles or full power cycles during the boot operation in response to checking the value of the flag. In some cases, the controller may determine to perform the limited power cycles based on the value of the flag indicating to perform the limited power cycles. In some such cases, the process 200 may continue to step 208. In other cases, the controller may determine to perform the full power cycles based on the value of the flag indicating to perform the full power cycles. In some such cases, the process 200 may continue to step 228.

At 208, the memory system may perform the boot operation based on (e.g., in response to) determining to perform the limited power cycles. For example, the memory system may perform one or more limited power cycles, each including one or more operations for transitioning the memory system from the relatively low power state to the relatively high power state. In some examples, the limited power cycles may include one or more operations directed to data generation, regeneration, and reliability. However, the limited power cycles may include relatively fewer operations directed to data generation, regeneration, and reliability than the full power cycles.

At 210, the memory system may perform a hardware reset during performing the boot cycle. In some cases, the memory system may perform the hardware reset during performing the limited power cycles. The hardware reset may include one or more operations associated with resetting one or more components of the memory system. In previous implementations, performing a hardware reset may change the value of the flag to indicate to perform the full power cycles during the boot cycle. However, as described herein, the hardware reset may not change the value of the flag.

At 212, the memory system may experience a power loss (e.g., an unexpected power loss, an asynchronous power loss) during performing the boot cycle. In some cases, the memory system may identify the power loss during performing the limited power cycles. The power loss may include a drop in power supplied to one or more components of the memory system. In previous implementations, identifying a power loss may change the value of the flag to indicate to perform the full power cycles during the boot cycle. However, as described herein, the power loss may not change the value of the flag.

At 214, the memory system may continue performing the limited power cycles as part of the boot cycle. For example, the memory system may perform the hardware reset or experience the power loss during performing the limited power cycles, and the memory system may continue performing the limited power cycles after the hardware reset is completed or after the power is restored. In some cases, continuing to perform the limited power cycles after the hardware reset or the power loss may include checking the flag to confirm the value of the flag still indicates to perform the limited power cycles.

At 216, the memory system may identify a write or erase operation. For example, the controller may check the command queue in the volatile memory device and determine whether one or more write or erase commands are present in the command queue. If the controller identifies a write or erase command during performing the boot cycle (e.g., during performing the limited power cycles), the controller may suspend the write or erase command, and refrain from performing the corresponding write or erase operation until the value of the flag is updated. If the controller identifies a write or erase command after completing the boot cycle, the controller may perform the corresponding write or erase operation.

At 218, the memory system may update the flag in response to identifying the write or erase operation. The memory system may update the value of the flag to indicate the memory system to perform the full power cycles. In some cases, updating the flag may include storing the updated value of the flag to the register. In some examples, if the controller identified the write or erase command during performing the boot cycle, the controller may suspend the write or erase command for a duration associated with updating the flag, and refrain from performing the corresponding write or erase operation for the duration associated with updating the flag.

At 220, the memory system may perform the write or erase operation in response to updating the flag. For example, the write or erase command may have been suspended for the duration associated with updating the flag, and the memory system may have refrained from performing the corresponding write or erase operation for the duration associated with updating the flag. However, after updating the flag, the memory system may cease suspending the write or erase command and perform the write or erase operation.

At 222, the memory system may continue performing the boot cycle based on (e.g., in response to) performing the full power cycles. The memory system may perform the full power cycles in response to updating the flag. In some cases, the memory system may perform the full power cycles for a duration associated with completing the boot cycle, such that the memory system may not perform limited power cycles during the remainder of the boot cycle (e.g., due to performing the write or erase operation). For example, the memory system may perform one or more full power cycles, each including one or more operations for transitioning the memory system from the relatively low power state to the relatively high power state. In some examples, the full power cycles may include one or more operations directed to data generation, regeneration, and reliability. Further, the full power cycles may include relatively more operations directed to data generation, regeneration, and reliability than the limited power cycles.

At 224, the memory system may power down using the SSU command. For example, after completing the boot cycle, the memory system may operate normally until the memory system is powered down by the SSU command. Powering down the memory system using the SSU command may update the value of the flag to indicate to perform limited power cycles during a next boot cycle for powering ON the memory system.

At 228, the memory system may update the flag based on (e.g., in response to) powering down via the SSU command because powering down in this manner ensures data reliability, such that operations directed to data generation, regeneration, and reliability may be unnecessary during the next boot cycle. Accordingly, after powering down the memory system using the SSU command, the value of the flag at a start of the next boot cycle may be set to indicate to perform the limited power cycles.

At 226, the memory system may be powered down based on (e.g., in response to) experiencing a power loss (e.g., an unexpected power loss, an asynchronous power loss). For example, after completing the boot cycle, the memory system may operate normally until the memory system experiences the power loss. Powering down the memory system via the power loss may not update the flag. For example, experiencing the power loss may maintain the value of the flag at the last set value, such that because the flag was last updated at step 318 to indicate to perform the full power cycles, the flag may indicate to perform the full power cycles during the next boot cycle. Accordingly, after powering down the memory system via the power loss, the value of the flag at a start of the next boot cycle may be set to indicate to perform the full power cycles. However, if the flag was not updated at step 318 and the memory system experienced the power loss, the flag may indicate to perform the limited power cycles during the next boot cycle.

At 230, the memory system may perform the boot operation based on (e.g., in response to) determining to perform the full power cycles. For example, the memory system may perform one or more full power cycles based on determining, at step 206, that the value of the flag indicates to perform the full power cycles. In some cases, the memory system may perform the full power cycles for a duration associated with completing the boot cycle, such that the memory system may not perform limited power cycles during the remainder of the boot cycle.

At 232, the memory system may perform a hardware reset during performing the boot cycle. In some cases, the memory system may perform the hardware reset during performing the full power cycles.

At 234, the memory system may experience a power loss (e.g., an unexpected power loss, an asynchronous power loss) during performing the boot cycle. In some cases, the memory system may identify the power loss during performing the full power cycles.

At 236, the memory system may continue performing the full power cycles as part of the boot cycle. For example, the memory system may perform the hardware reset or experience the power loss during performing the full power cycles, and the memory system may continue performing the full power cycles after the hardware reset is completed or after the power is restored. In some cases, continuing to perform the full power cycles after the hardware reset or the power loss may include checking the flag to confirm the value of the flag still indicates to perform the full power cycles.

At 238, the memory system may perform a write or erase operation. For example, the controller may check the command queue in the volatile memory device and determine that one or more write or erase commands are present in the command queue. The memory system may perform the corresponding write or erase operations in response to identifying the one or more write or erase commands in the command queue. In some such examples, the memory system may not update the flag in response to performing the write or erase operation.

At 240, the memory system may continue performing the boot cycle based on (e.g., in response to) performing the full power cycles. Eventually the memory system may return to 224 or 226.

At 224, the memory system may power down using the SSU command. For example, after completing the boot cycle, the memory system may operate normally until the memory system is powered down by the SSU command. Powering down the memory system using the SSU command may update the value of the flag to indicate to perform limited power cycles during a next boot cycle for powering ON the memory system.

At 228, the memory system may update the flag based on (e.g., in response to) powering down via the SSU command because powering down in this manner ensures data reliability, such that operations directed to data generation, regeneration, and reliability may be unnecessary during the next boot cycle. Accordingly, after powering down the memory system using the SSU command, the value of the flag at a start of the next boot cycle may be set to indicate to perform the limited power cycles.

At 226, the memory system may be powered down based on (e.g., in response to) experiencing a power loss (e.g., an unexpected power loss, an asynchronous power loss). For example, after completing the boot cycle, the memory system may operate normally until the memory system experiences the power loss. Powering down the memory system via the power loss may not update the flag. For example, experiencing the power loss may maintain the value of the flag at the last set value, such that because the flag indicated to perform the full power cycles, the flag may continue to indicate to perform the full power cycles during the next boot cycle. Accordingly, after powering down the memory system via the power loss, the value of the flag at a start of the next boot cycle may be set to indicate to perform the full power cycles.

In accordance with examples as described herein, the memory system may be configured to perform the limited power cycles in response to conditions of the memory system. For example, the limited power cycles may be implemented in the boot cycle after powering down the memory system via the SSU command, and may continue to be implemented until a write operation is identified at the memory system. The limited power cycles may be associated with reduced bandwidth consumption and latency when compared to performing the full power cycles. Thus, implementing one or more limited power cycles in the boot cycle may at least partially reduce bandwidth consumption and latency compared to previous implementations.

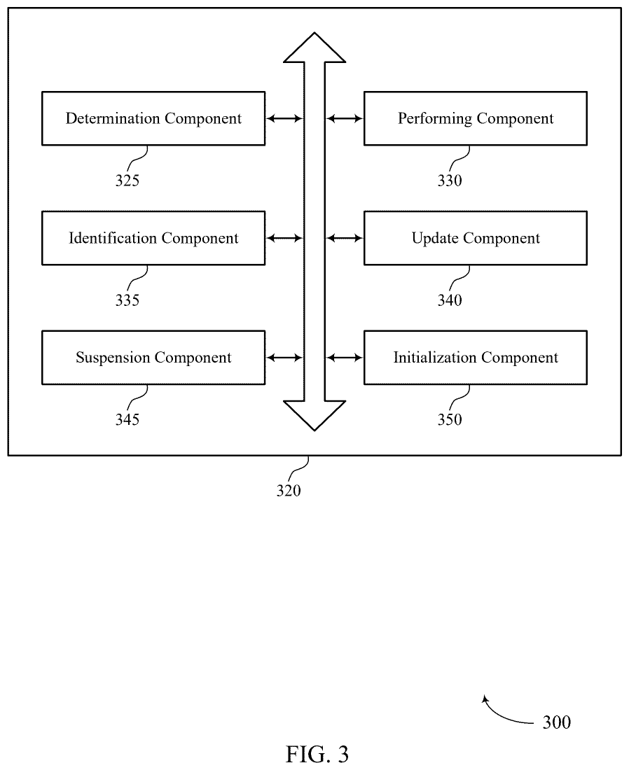

FIG. 3 shows a block diagram 300 of a memory system 320 that supports selective boot cycle modes in accordance with examples as disclosed herein. The memory system 320 may be an example of aspects of a memory system as described with reference to FIGS. 1 through 2. The memory system 320, or various components thereof, may be an example of means for performing various aspects of selective boot cycle modes as described herein. For example, the memory system 320 may include a determination component 325, a performing component 330, an identification component 335, an update component 340, a suspension component 345, an initialization component 350, or any combination thereof. Each of these components, or components of subcomponents thereof (e.g., one or more processors, one or more memories), may communicate, directly or indirectly, with one another (e.g., via one or more buses).

The determination component 325 may be configured as or otherwise support a means for determining whether to perform at least one first power cycle or at least one second power cycle as part of a boot cycle based at least in part on a value of a flag stored in a memory system, each power cycle including operations for transitioning the memory system from a low power state to a high power state, where the at least one first power cycle includes a greater quantity of operations than the at least one second power cycle. The performing component 330 may be configured as or otherwise support a means for performing the at least one second power cycle based at least in part on determining that the value of the flag indicates to perform the at least one second power cycle. The identification component 335 may be configured as or otherwise support a means for identifying at least one write operation associated with the memory system. The update component 340 may be configured as or otherwise support a means for updating the value of the flag to indicate to the memory system to perform the at least one first power cycle based at least in part on identifying the at least one write operation.

In some examples, the performing component 330 may be configured as or otherwise support a means for performing the at least one first power cycle based at least in part on updating the value of the flag.

In some examples, the suspension component 345 may be configured as or otherwise support a means for suspending performing the at least one write operation for a duration associated with updating the value of the flag. In some examples, the performing component 330 may be configured as or otherwise support a means for performing the at least one write operation based at least in part on updating the value of the flag.

In some examples, the update component 340 may be configured as or otherwise support a means for updating the value of the flag to indicate to the memory system to perform the at least one second power cycle based at least in part on switching the memory system from the high power state to the low power state using a start stop unit.

In some examples, the performing component 330 may be configured as or otherwise support a means for performing a hardware reset at the memory system while performing the boot cycle. In some examples, the performing component 330 may be configured as or otherwise support a means for continuing to perform the at least one second power cycle after completing the hardware reset and based at least in part on the value of the flag indicating to perform the at least one second power cycle.

In some examples, the identification component 335 may be configured as or otherwise support a means for identifying a power loss event at the memory system while performing the boot cycle. In some examples, the performing component 330 may be configured as or otherwise support a means for continuing to perform the at least one second power cycle after identifying the power loss event and based at least in part on the value of the flag indicating to perform the at least one second power cycle.

In some examples, the initialization component 350 may be configured as or otherwise support a means for initializing the boot cycle at the memory system. In some examples, the determination component 325 may be configured as or otherwise support a means for determining whether to perform the at least one first power cycle or the at least one second power cycle based at least in part on initializing the boot cycle.

In some examples, the identification component 335 may be configured as or otherwise support a means for identifying a power loss event at the memory system. In some examples, the determination component 325 may be configured as or otherwise support a means for determining whether to perform the at least one first power cycle or the at least one second power cycle based at least in part on identifying the power loss event.

In some examples, the performing component 330 may be configured as or otherwise support a means for performing a hardware reset at the memory system as part of the boot cycle. In some examples, the determination component 325 may be configured as or otherwise support a means for determining whether to perform the at least one first power cycle or the at least one second power cycle based at least in part on performing the hardware reset as part of the boot cycle.

In some examples, to support identifying the at least one write operation, the identification component 335 may be configured as or otherwise support a means for identifying at least one write command in a command queue of the memory system.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

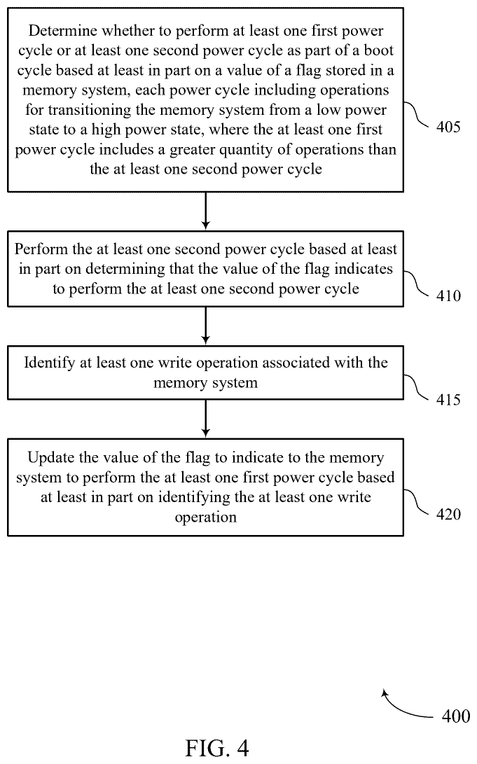

FIG. 4 shows a flowchart illustrating a method 400 that supports selective boot cycle modes in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include determining whether to perform at least one first power cycle or at least one second power cycle as part of a boot cycle based at least in part on a value of a flag stored in a memory system, each power cycle including operations for transitioning the memory system from a low power state to a high power state, where the at least one first power cycle includes a greater quantity of operations than the at least one second power cycle. In some examples, aspects of the operations of 405 may be performed by a determination component 325 as described with reference to FIG. 3.

At 410, the method may include performing the at least one second power cycle based at least in part on determining that the value of the flag indicates to perform the at least one second power cycle. In some examples, aspects of the operations of 410 may be performed by a performing component 330 as described with reference to FIG. 3.

At 415, the method may include identifying at least one write operation associated with the memory system. In some examples, aspects of the operations of 415 may be performed by an identification component 335 as described with reference to FIG. 3.

At 420, the method may include updating the value of the flag to indicate to the memory system to perform the at least one first power cycle based at least in part on identifying the at least one write operation. In some examples, aspects of the operations of 420 may be performed by an update component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether to perform at least one first power cycle or at least one second power cycle as part of a boot cycle based at least in part on a value of a flag stored in a memory system, each power cycle including operations for transitioning the memory system from a low power state to a high power state, where the at least one first power cycle includes a greater quantity of operations than the at least one second power cycle; performing the at least one second power cycle based at least in part on determining that the value of the flag indicates to perform the at least one second power cycle; identifying at least one write operation associated with the memory system; and updating the value of the flag to indicate to the memory system to perform the at least one first power cycle based at least in part on identifying the at least one write operation.

Aspect 2: The method, apparatus, or non-transitory computer-readable medium of aspect 1, further including operations, features, circuitry, logic, means, or instructions, or any combination thereof for performing the at least one first power cycle based at least in part on updating the value of the flag.

Aspect 3: The method, apparatus, or non-transitory computer-readable medium of any of aspects 1 through 2, further including operations, features, circuitry, logic, means, or instructions, or any combination thereof for suspending performing the at least one write operation for a duration associated with updating the value of the flag and performing the at least one write operation based at least in part on updating the value of the flag.

Aspect 4: The method, apparatus, or non-transitory computer-readable medium of any of aspects 1 through 3, further including operations, features, circuitry, logic, means, or instructions, or any combination thereof for updating the value of the flag to indicate to the memory system to perform the at least one second power cycle based at least in part on switching the memory system from the high power state to the low power state using a start stop unit.

Aspect 5: The method, apparatus, or non-transitory computer-readable medium of any of aspects 1 through 4, further including operations, features, circuitry, logic, means, or instructions, or any combination thereof for performing a hardware reset at the memory system while performing the boot cycle and continuing to perform the at least one second power cycle after completing the hardware reset and based at least in part on the value of the flag indicating to perform the at least one second power cycle.

Aspect 6: The method, apparatus, or non-transitory computer-readable medium of any of aspects 1 through 5, further including operations, features, circuitry, logic, means, or instructions, or any combination thereof for identifying a power loss event at the memory system while performing the boot cycle and continuing to perform the at least one second power cycle after identifying the power loss event and based at least in part on the value of the flag indicating to perform the at least one second power cycle.

Aspect 7: The method, apparatus, or non-transitory computer-readable medium of any of aspects 1 through 6, further including operations, features, circuitry, logic, means, or instructions, or any combination thereof for initializing the boot cycle at the memory system and where determining whether to perform the at least one first power cycle or the at least one second power cycle is based at least in part on initializing the boot cycle.

Aspect 8: The method, apparatus, or non-transitory computer-readable medium of any of aspects 1 through 7, further including operations, features, circuitry, logic, means, or instructions, or any combination thereof for identifying a power loss event at the memory system and where determining whether to perform the at least one first power cycle or the at least one second power cycle is based at least in part on identifying the power loss event.

Aspect 9: The method, apparatus, or non-transitory computer-readable medium of any of aspects 1 through 8, further including operations, features, circuitry, logic, means, or instructions, or any combination thereof for performing a hardware reset at the memory system as part of the boot cycle and where determining whether to perform the at least one first power cycle or the at least one second power cycle is based at least in part on performing the hardware reset as part of the boot cycle.

Aspect 10: The method, apparatus, or non-transitory computer-readable medium of any of aspects 1 through 9, where identifying the at least one write operation includes operations, features, circuitry, logic, means, or instructions, or any combination thereof for identifying at least one write command in a command queue of the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “OFF” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
at least one memory system; and
at least one controller coupled with the at least one memory system and configured to cause the apparatus to:
determine whether to perform at least one first power cycle or at least one second power cycle as part of a boot cycle based at least in part on a value of a flag stored in the at least one memory system, each power cycle comprising operations for transitioning the at least one memory system from a low power state to a high power state, wherein the at least one first power cycle comprises a greater quantity of operations than the at least one second power cycle;
perform the at least one second power cycle based at least in part on determining that the value of the flag indicates to perform the at least one second power cycle;
identify at least one write operation associated with the at least one memory system; and
update the value of the flag to indicate to the at least one memory system to perform the at least one first power cycle based at least in part on identifying the at least one write operation.

2. The apparatus of claim 1, wherein the at least one controller is further configured to cause the apparatus to:
perform the at least one first power cycle based at least in part on updating the value of the flag.

3. The apparatus of claim 1, wherein the at least one controller is further configured to cause the apparatus to:
suspend performing the at least one write operation for a duration associated with updating the value of the flag; and
perform the at least one write operation based at least in part on updating the value of the flag.

4. The apparatus of claim 1, wherein the at least one controller is further configured to cause the apparatus to:
update the value of the flag to indicate to the at least one memory system to perform the at least one second power cycle based at least in part on switching the at least one memory system from the high power state to the low power state using a start stop unit.

5. The apparatus of claim 1, wherein the at least one controller is further configured to cause the apparatus to:
perform a hardware reset at the at least one memory system while performing the boot cycle; and
continue to perform the at least one second power cycle after completing the hardware reset and based at least in part on the value of the flag indicating to perform the at least one second power cycle.

6. The apparatus of claim 1, wherein the at least one controller is further configured to cause the apparatus to:
identify a power loss event at the at least one memory system while performing the boot cycle; and
continue to perform the at least one second power cycle after identifying the power loss event and based at least in part on the value of the flag indicating to perform the at least one second power cycle.

7. The apparatus of claim 1, wherein the at least one controller is further configured to cause the apparatus to:
initialize the boot cycle at the at least one memory system,
wherein to determine whether to perform the at least one first power cycle or the at least one second power cycle is based at least in part on initializing the boot cycle.

8. The apparatus of claim 1, wherein the at least one controller is further configured to cause the apparatus to:
identify a power loss event at the at least one memory system,
wherein to determine whether to perform the at least one first power cycle or the at least one second power cycle is based at least in part on identifying the power loss event.

9. The apparatus of claim 1, wherein the at least one controller is further configured to cause the apparatus to:
perform a hardware reset at the at least one memory system as part of the boot cycle,
wherein to determine whether to perform the at least one first power cycle or the at least one second power cycle is based at least in part on performing the hardware reset as part of the boot cycle.

10. The apparatus of claim 1, wherein identifying the at least one write operation is configured to cause the apparatus to:
identify at least one write command in a command queue of the at least one memory system.

11. A non-transitory computer-readable medium storing code comprising instructions which, when executed by a processor of an electronic device, cause the electronic device to:
determine whether to perform at least one first power cycle or at least one second power cycle as part of a boot cycle based at least in part on a value of a flag stored in a memory system, each power cycle comprising operations for transitioning the memory system from a low power state to a high power state, wherein the at least one first power cycle comprises a greater quantity of operations than the at least one second power cycle;
perform the at least one second power cycle based at least in part on determining that the value of the flag indicates to perform the at least one second power cycle;
identify at least one write operation associated with the memory system; and
update the value of the flag to indicate to the memory system to perform the at least one first power cycle based at least in part on identifying the at least one write operation.

12. The non-transitory computer-readable medium of claim 11, wherein the instructions, when executed by the processor of the electronic device, further cause the electronic device to:
perform the at least one first power cycle based at least in part on updating the value of the flag.

13. The non-transitory computer-readable medium of claim 11, wherein the instructions, when executed by the processor of the electronic device, further cause the electronic device to:
suspend performing the at least one write operation for a duration associated with updating the value of the flag; and
perform the at least one write operation based at least in part on updating the value of the flag.

14. The non-transitory computer-readable medium of claim 11, wherein the instructions, when executed by the processor of the electronic device, further cause the electronic device to:
update the value of the flag to indicate to the memory system to perform the at least one second power cycle based at least in part on switching the memory system from the high power state to the low power state using a start stop unit.

15. The non-transitory computer-readable medium of claim 11, wherein the instructions, when executed by the processor of the electronic device, further cause the electronic device to:
perform a hardware reset at the memory system while performing the boot cycle; and
continue to perform the at least one second power cycle after completing the hardware reset and based at least in part on the value of the flag indicating to perform the at least one second power cycle.

16. The non-transitory computer-readable medium of claim 11, wherein the instructions, when executed by the processor of the electronic device, further cause the electronic device to:
identify a power loss event at the memory system while performing the boot cycle; and
continue to perform the at least one second power cycle after identifying the power loss event and based at least in part on the value of the flag indicating to perform the at least one second power cycle.

17. The non-transitory computer-readable medium of claim 11, wherein the instructions, when executed by the processor of the electronic device, further cause the electronic device to:
initialize the boot cycle at the memory system,
wherein to determine whether to perform the at least one first power cycle or the at least one second power cycle is based at least in part on initializing the boot cycle.

18. The non-transitory computer-readable medium of claim 11, wherein the instructions, when executed by the processor of the electronic device, further cause the electronic device to:
identify a power loss event at the memory system,
wherein to determine whether to perform the at least one first power cycle or the at least one second power cycle is based at least in part on identifying the power loss event.

19. The non-transitory computer-readable medium of claim 11, wherein the instructions, when executed by the processor of the electronic device, further cause the electronic device to:
perform a hardware reset at the memory system as part of the boot cycle,
wherein to determine whether to perform the at least one first power cycle or the at least one second power cycle is based at least in part on performing the hardware reset as part of the boot cycle.

20. A method, comprising:
determining whether to perform at least one first power cycle or at least one second power cycle as part of a boot cycle based at least in part on a value of a flag stored in a memory system, each power cycle comprising operations for transitioning the memory system from a low power state to a high power state, wherein the at least one first power cycle comprises a greater quantity of operations than the at least one second power cycle;
performing the at least one second power cycle based at least in part on determining that the value of the flag indicates to perform the at least one second power cycle;
identifying at least one write operation associated with the memory system; and
updating the value of the flag to indicate to the memory system to perform the at least one first power cycle based at least in part on identifying the at least one write operation.
